(19) United States
(12) Patent Application Publication
(10) Pub. No.: US 2018/0196813 A1
(43) Pub. Date: Jul. 12, 2018

(54) SYSTEMS AND METHODS TO IDENTIFY INFLUENCERS IN A SOCIAL NETWORKING SYSTEM

(71) Applicant: Facebook, Inc., Menlo Park, CA (US)

(72) Inventors: Shuyang Lin, Menlo Park, CA (US); Mei Gao, Menlo Park, CA (US)

(21) Appl. No.: 15/404,068

(22) Filed: Jan. 11, 2017

(51) Int. Cl. G06F 17/30; H04L 29/08

(52) U.S. Cl. CPC G06F 17/3053; H04L 67/22

(57) ABSTRACT

Systems, methods, and non-transitory computer readable media are configured to determine one or more weights associated with connections between nodes representing users in a first graph. The one or more weights are adjusted based at least in part on an impact metric associated with a first user based on a second graph. An influence score associated with the first user is generated based on the one or more weights.

### FIELD OF THE INVENTION

The present technology relates to social networking system interactions. More particularly, the present technology relates to techniques for identifying users who can influence interactions on a social networking system.

### BACKGROUND

Today, people often utilize computing devices (or systems) for a wide variety of purposes. Users can use their computing devices to, for example, interact with one another, access content, share content, and create content. A social networking system can provide platform for such activities. For example, a social networking system can allow its users to post information. The posts can include media content items, such as images and video, as well as other information, such as events.

The posts can be published to the social networking system to invite consideration by and action of others. For example, when a post relates to an event, a user receiving the post can choose to take appropriate action, such as participating in the event, as warranted. As another example, when a post relates to a media content item, a user receiving the post can take appropriate action, such as liking (or fanning) the post, commenting on the post, or sharing the post with other users. In certain circumstances, an action by a user in the social networking system can prompt other users to take similar action.

### SUMMARY

Various embodiments of the present technology can include systems, methods, and non-transitory computer readable media configured to determine one or more weights associated with connections between nodes representing users in a first graph. The one or more weights are adjusted based at least in part on an impact metric associated with a first user based on a second graph. An influence score associated with the first user is generated based on the one or more weights.

In some embodiments, the one or more weights reflect a relationship between a first node associated with the first user and a second node associated with a second user.

In some embodiments, the one or more weights are based on at least one of a first parameter relating to a count of times that the second user took action in response to action taken by a first user, a second parameter relating to a count of times that the second user received an invitation to take action from the first user, and a third parameter relating to a coefficient value representing an affinity between the first user and the second user.

In some embodiments, the impact metric is determined from a component graph of the second graph.

In some embodiments, the impact metric is based on a count of other users who took downstream action in direct or indirect response to an action taken by the first user as reflected in an associated component graph.

In some embodiments, a component graph of the second graph reflecting the first user who took an action and other users who took downstream action in direct or indirect response to the action taken by the first user is generated.

In some embodiments, the component graph relates to a type of activity.

In some embodiments, the type of activity relates to at least one of participation in an event, engagement with a media content item, or interaction with entities on a social networking system.

In some embodiments, adjustment of the one or more weights comprises: determining a difference value based on the influence score and an impact metric associated with the first user; and training the one or more weights based on the difference value.

In some embodiments, the second graph comprises at least one component graph including nodes associated with user-activity pairs, the at least one component graph representing an action and associated downstream actions.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example influence determination module, according to an embodiment of the present technology.

FIG. 2A illustrates an example score generation module, according to an embodiment of the present technology.

FIG. 2B illustrates an example score evaluation module, according to an embodiment of the present technology.

FIG. 3 illustrates an example scenario for determining an influence score, according to an embodiment of the present technology.

FIG. 4 illustrates an example method to determine an influence score, according to an embodiment of the present technology.

FIG. 5 illustrates an example method to adjust weights on which an influence score is based, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Influence Determination in a Social Networking System

As discussed, people often utilize computing devices (or systems) for a wide variety of purposes. Users can use their computing devices to, for example, interact with one another, access content, share content, and create content. A social networking system can provide platform for such activities. For example, a social networking system can allow its users to post information. The posts can include media content items, such as images and video, as well as other information, such as events.

The posts can be published to the social networking system to invite consideration by and action of others. For example, when a post relates to an event, a user receiving the post can choose to take appropriate action, such as participating in the event, as warranted. As another example, when a post relates to a media content item, a user receiving the post can take appropriate action, such as liking (or fanning) the post, commenting on the post, or sharing the post with other users. In certain circumstances, an action by a user in the social networking system can prompt other users to take similar action.

The ability of a user to prompt other users to take action can reflect an influence of the user in the social networking system. For example, if a first user joins (or indicates an intention to join) an event that is hosted on the social networking system, a second user who learns about such joining on the social networking system also may join the event. For example, the second user may learn about the joining of the event by the first user through a news feed of the second user provided through the social networking system. Likewise, a third user who learns on the social networking system that the second user joined the event also may join the event. Based on the joining of the event by the first user, more possible downstream joining of the event by additional users can occur in a similar manner. In this regard, one disadvantage of a conventional social networking system is the inability to accurately predict a measure of influence of a first user in relation to taking an action that causes downstream action by other users.

An improved approach rooted in computer technology overcomes the foregoing and other disadvantages associated with conventional approaches specifically arising in the realm of computer technology. Systems, methods, and computer readable media of the present technology can create a first graph that reflects relationships of users on a social networking system. The first graph can include nodes that represent the users. Connections (or edges) between nodes can be represented by weights (or edge weights). A weight of a connection between nodes can reflect values of parameters associated with a level of interaction or affinity between users associated with the nodes. A scoring technique can determine an influence score for a user based on weights of the connections of the first graph. Based on their influence scores, users having high levels of influence can be identified. The accuracy of an influence score for a user can be analyzed based on evaluation data. In this regard, a second graph can be generated. The second graph can reflect a plurality of component graphs associated with activities that have occurred on the social networking system. In some instances, the activities reflected in the second graph have occurred after occurrence of the activities reflected in the first graph. Each component graph can relate to a certain type of activity and can represent a user, who took an initial action, as a node and can represent downstream users, who directly or indirectly took actions in response to the initial action, as additional nodes that are appropriately linked through connections in the component graph. With respect to a certain type of activity, the second graph can be analyzed in relation to a user for whom accuracy of a determined influence score is to be evaluated. In particular, one or more component graphs associated with the certain type of activity and reflecting an action taken by the user can be identified in the second graph. Based on a count of actions downstream from the user in the component graphs, an impact metric can be determined for the user. The impact metric can be compared with the influence score. Differences between the influence score and the impact metric can be used to train or adjust the weights of the connections of the first graph to generate more accurate influence scores for users. More details regarding the present technology are described herein.

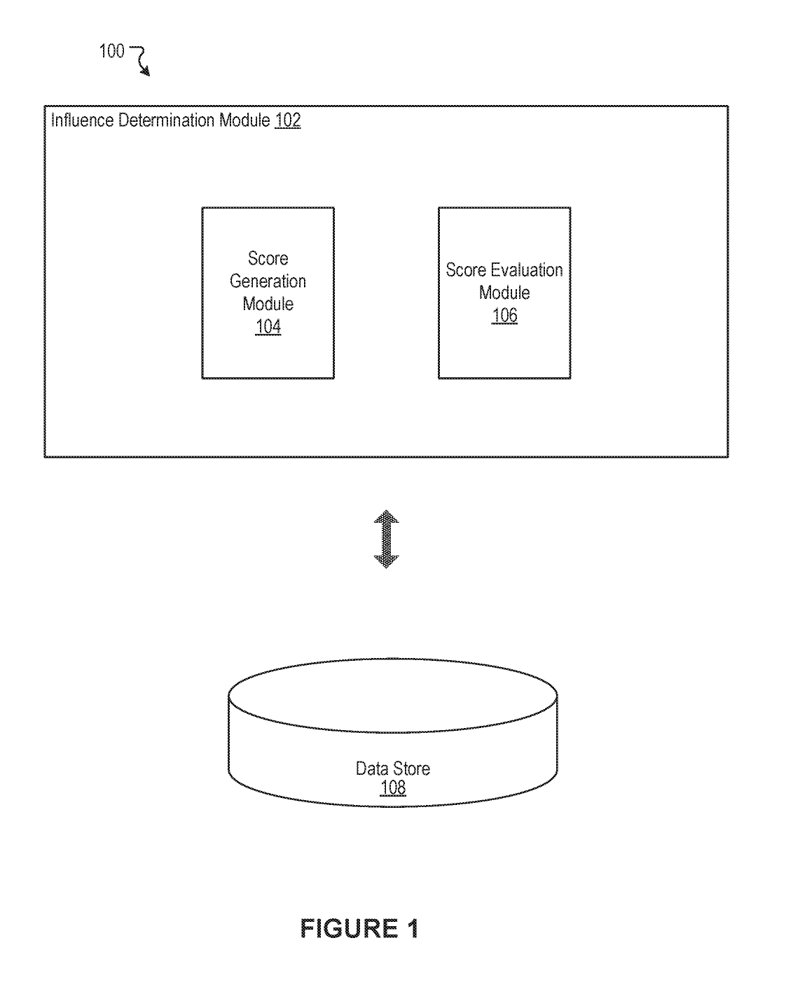

FIG. 1 illustrates an example system 100 including an example influence determination module 102 configured to determine an influence score for a user of a system, such as a social networking system, according to an embodiment of the present technology. The influence determination module 102 can be used to determine an influence score that, based on an action by a user in a social networking system, measures a level of influence of the user in directly or indirectly prompting or causing action by other users in the social networking system. The action can be associated with one of various types of activities that can occur on the social networking system. The types of activities can be any cascade of occurrences or interactions on the social networking system that can involve an action taken by a first user that results in downstream actions taken by other users in direct or indirect response to the action taken by the first user. The types of activities can include, for example, participation in an event (e.g., joining an event), engagement with (e.g., liking, commenting on, sharing, etc.) a media content item, interacting with (e.g., contacting, messaging, connecting with, following, etc.) entities (e.g., profiles, pages) on the social networking system. While activities relating to participation in events are herein discussed as examples, the present technology applies to any type of activity.

The influence determination module 102 can be used to identify users in a social networking system that have a selected level of influence. In some embodiments, the identification of users having a high level of influence (e.g., a level of influence that satisfies a threshold) can be used to effectively propagate desired action or information through the social networking system. For example, a first user having a high level of influence can be invited to take desired action with respect to a certain activity. As just one example, the desired action can be joining an event. If the first user takes the desired action, an indication of such action can be provided to connections of the first user or other users of the social networking system. Further, the indication can be configured to allow a user to access the indication to likewise take the same desired action. For example, a user interface of a computing device through which the indication can be displayed can allow a user to take the desired action. In some instances, the indication can be reflected in a story or other content item that is published in the social networking system through news feeds of users. A second user can take the desired action in direct response to the action taken by the first user. Likewise, a third user can take the desired action in direct response to the action taken by the first user. An indication referencing the action taken by the second user and inviting the same desired action can be provided to connections of the second user or other users of the social networking system. As a result, a fourth user can take the desired action in direct response to the action taken by the second user and in indirect response to the action taken by the first user. An indication referencing the action taken by the fourth user and inviting the same desired action can be provided to connections of the fourth user or other users of the social networking system. As a result, a fifth user can take the desired action in direct response to the fourth user and in indirect response to the first user. In a similar manner, additional users can take the desired action in direct and indirect response to action taken by the first user. Because the first user has a high level of influence, a relatively large number of other users can be expected to take similar, downstream actions in direct or indirect response to the action taken by the first user. As a result, the desired action can be effectively propagated through the social networking system. In some cases, an advertisement or other information can be selected for placement in indications (e.g., stories) referencing actions taken by users and inviting the same desired actions. The placement of the advertisement or other information in such indications also can effectively propagate the advertisement or other information through the social networking system. The extent to which an action can be propagated through a social networking system can be based at least in part on a level of influence of a first user taking the action.

The influence determination module 102 can include a score generation module 104 and a score evaluation module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the influence determination module 102 can be implemented in any suitable combinations.

The score generation module 104 can generate a first graph reflecting relationships of users on a social networking system. The first graph can include nodes representing the users and connections between nodes represented by weights. A weight can reflect one or more parameters that describe a relationship between two nodes. Weights can be trained and adjusted based on impact metrics determined from analysis of evaluation data. Based on the weights of the first graph, a scoring technique can determine an influence score for a user. Users having high levels of influence can be identified based on their influence scores. Functionality of the score generation module 104 is discussed in more detail herein.

The score evaluation module 106 can generate a second graph reflecting a plurality of component graphs. Each component graph can relate to a certain type of activity and an action taken by a first user and actions taken in direct and indirect response by other users. An impact metric can be determined for a first user based on a count of downstream actions taken by other users in direct and indirect response to the action taken by the first user. Differences between the influence score and the impact metric can be used to train or adjust the weights of the connections of the first graph, as indicated, to generate a more accurate influence score for the user.

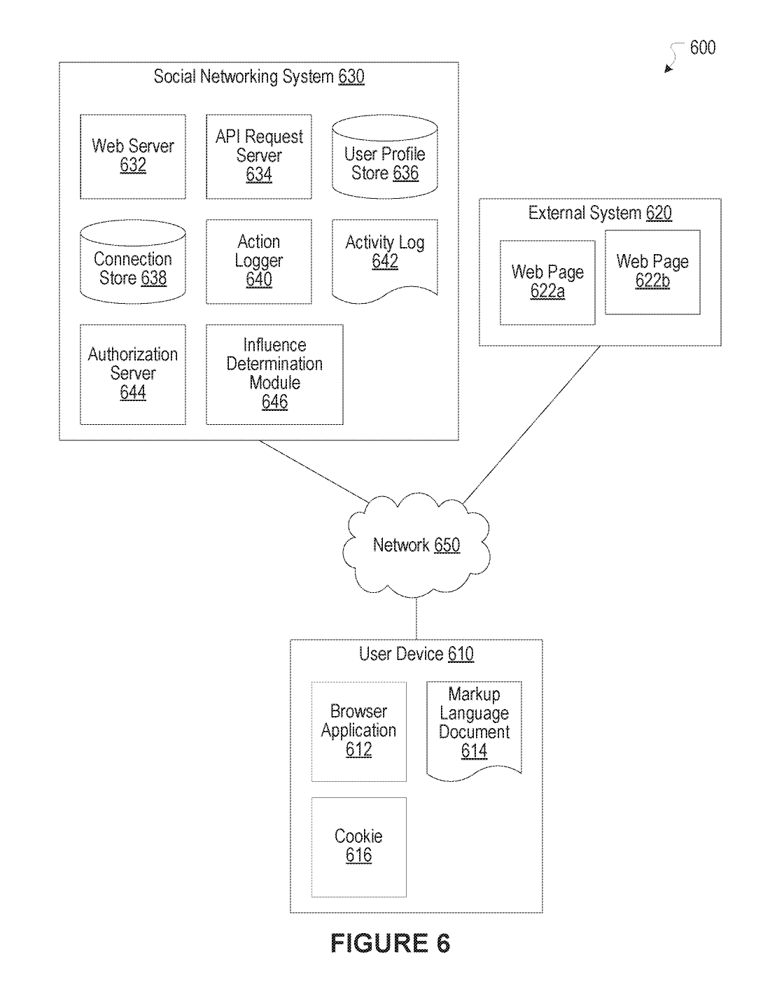

In some embodiments, the influence determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the influence determination module 102 can be, in part or in whole, implemented as software running on one or more computing devices or systems, such as on a server or a client computing device. For example, the influence determination module 102 can be, in part or in whole, implemented within or configured to operate in conjunction or be integrated with a social networking system (or service), such as a social networking system 630 of FIG. 6. As another example, the influence determination module 102 can be implemented as or within a dedicated application (e.g., app), a program, or an applet running on a user computing device or client computing system. In some instances, the influence determination module 102 can be, in part or in whole, implemented within or configured to operate in conjunction or be integrated with client computing device, such as a user device 610 of FIG. 6. It should be understood that many variations are possible.

The system 100 can include a data store 108 configured to store and maintain various types of data, such as the data relating to support of and operation of the influence determination module 102. The data can include, for example, identifiers associated with entities, original feature dimensionality, desired feature dimensionality, embedding models, features values, machine learning models, training data, etc. The data store 108 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the influence determination module 102 can be configured to communicate and/or operate with the data store 108.

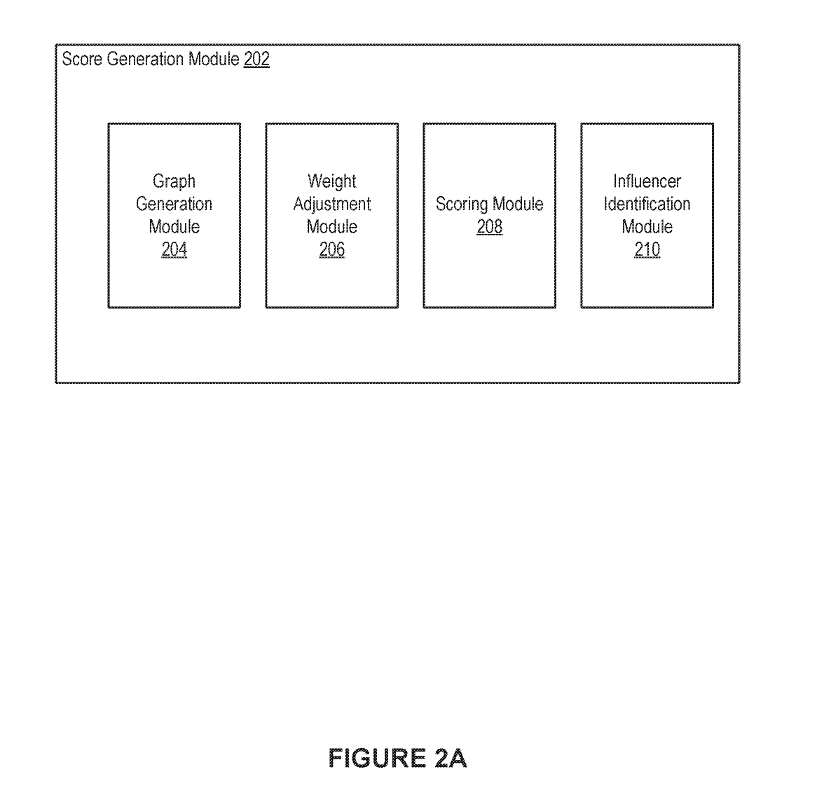

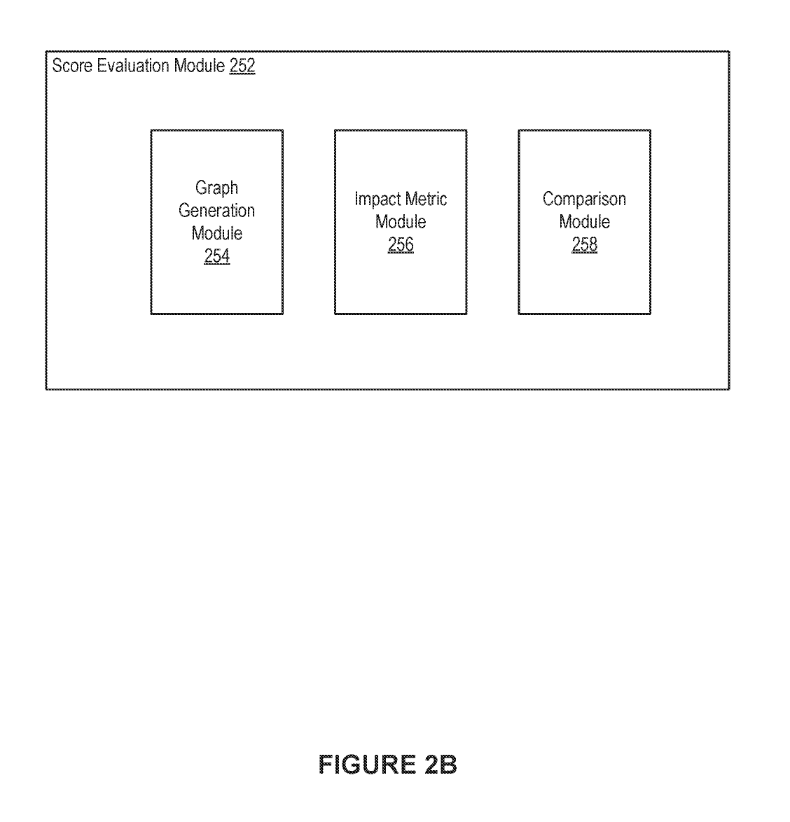

FIG. 2A illustrates an example score generation module 202, according to an embodiment of the present technology. The score generation module 202 can generate an influence score for each user of a plurality of users on a social networking system. In some embodiments, the score generation module 104 of FIG. 1 can be implemented with the score generation module 202. The score generation module 202 can include a graph generation module 204, a weight adjustment module 206, a scoring module 208, and an influencer identification module 210.

The graph generation module 204 can generate a first graph reflecting relationships of users of a social networking system. The first graph can include nodes representing the users and connections between nodes represented by weights. In some embodiments, the first graph can reflect users associated with all types of activities in which actions taken by some directly or indirectly resulted in the same actions taken by others. Influence of a user can depend on a type of activity. In various embodiments, the first graph can reflect one type of activity or many types of activities in which actions taken by users directly or indirectly resulted in the same actions taken by other users. For example, the first graph can reflect only the type of activity relating to events. As another example, the first graph can reflect only the type of activity relating to engagement with media content items (e.g., liking a media content item). In some embodiments, the first graph can reflect a particular vertical relating to a type of activity. For example, with respect to the type of activity relating to participation in events, the first graph can relate to any suitable vertical categorization, such as travel, entertainment, politics, sports, charities, etc. The first graph can reflect activities that have occurred during a selected first time duration. The selected first duration of time can be any suitable time period.

A weight can be based on one or more parameters that describe a relationship between two nodes. The parameters can include any indicia that are descriptive of a level of relationship, engagement, or affinity between two nodes. In some embodiments, the weights can be directional. In some embodiments, the parameters can include, for example, a first parameter relating to a count of times that a second user took action in response to action taken by a first user, a second a parameter relating to a count of times that a second user received an invitation to take action from a first user, and a third parameter relating to a coefficient value representing a relationship strength between the first user and the second user. In an implementation relating to a type of activity involving events, the first parameter can relate to a count of times that a second user joined an event in response to a first user joining the event and the second parameter can relate to a count of times that a second user received an invitation to an event from a first user. Other parameters are possible. The parameters relating to two nodes can be combined to generate the weight between the nodes in any suitable manner. In various embodiments, the parameters can be combined by summation, multiplication, normalization and combination, etc.

The weight adjustment module 206 can train and adjust weights in the first graph. The weights can be trained and adjusted based on a comparison of or difference between an influence score generated by the score generation module 104 for a first user and an impact metric determined by the score evaluation module 106 for the first user. The impact metric can constitute a measure of influence relating to a first user as determined through recent activities involving the first user, as described in more detail herein. In some embodiments, an optimization technique can be used to tune the values of the weights, or the parameters on which they are based, so that a difference value between the influence score and the impact metric is minimized or driven toward a zero value. In some embodiments, the difference value can reflect a comparison of influence scores and impact metrics across one or more activities or one or more types of activities.

The scoring module 208 can generate an influence score for a first user based on weights determined by the graph generation module 204 and the weight adjustment module 206. A scoring technique can determine an influence score based on the weights. In some embodiments, the scoring technique can include, for example, a page rank algorithm that determines the relative importance of the nodes in the first graph as an indication of influence. In some embodiments, the scoring technique can employ other algorithms. The influence score constitutes a measure of direct influence and indirect influence of a first user. In this regard, the influence score constitutes a measure of influence relating to an ability of the first user to take action that prompts similar actions by others in a cascading manner. In some embodiments, when the first graph relates to various types of activities, the influence score of a first user can be a measure of influence of the first user for the various types of activities or a general measure of influence of the first user. In some embodiments, when the first graph relates to a certain type of activity, the influence score of a first user can be a measure of influence of the first user with respect to the certain type of activity. The scoring module 208 can generate an influence score for each node (or associated user) in the first graph.

The influencer identification module 210 can identify users having highest levels of influence. The users represented as nodes in a first graph can be ranked based on their influence scores. In some embodiments, a selected number of users associated with highest influence scores can be identified as the users having highest levels of influence. In some embodiments, users associated with influence scores that satisfy a selected threshold value can be identified as the users having highest levels of influence. In some embodiments, a set of users having highest levels of influence without regard to a type of activity (or across various types of activities) can be identified based on their influence scores having highest values. In one example with respect to such embodiments, the influence scores having highest values can be generated based on a first graph reflecting various types of activities. In some embodiments, a set of users having highest levels of influence with regard to a particular type (or types) of activity can be identified based on their influence scores having highest values. In one example with respect to such embodiments, the influence scores having highest values can be generated based on a first graph reflecting only the particular type (or types) of activity. In some embodiments, a rank aggregation technique can be used to identify a set of users having highest levels of influence across various types of activities from a plurality of sets of users having highest levels of influence, with each set in the plurality relating to a respective type of activity. Identification of users having highest levels of influence can be targeted on a social networking system and prompted to take desired action so that the desired action can be optimally propagated through the social networking system by downstream users who also take the desired action.

FIG. 2B illustrates an example score evaluation module 252, according to an embodiment of the present technology. The score evaluation module 252 can generate impact metrics as evaluation data that informs the accuracy of influence scores generated for users. In some embodiments, the score evaluation module 106 of FIG. 1 can be implemented with the score evaluation module 252. The score evaluation module 252 can include a graph generation module 254, an impact metric module 256, and a comparison module 258.

The graph generation module 254 can generate a second graph including a plurality of component graphs. Each component graph can relate to a particular type of activity. The plurality of component graphs can reflect various types of activities. In some embodiments, the second graph can reflect activities that have occurred during a selected second time period. In some embodiments, the selected second time period can occur after the selected first time period reflected in the first graph generated by the graph generation module 204. The selected second time period can be any suitable duration of time (e.g., a month). In some embodiments, each component graph can be represented in the second graph as a directed acylic graph (or DAG). The plurality of component graphs can be provided to a digraph platform for processing in accordance with the functionality of the score evaluation module 252.

Each component graph can reflect a type of activity involving an action taken by a first user and downstream actions taken by other users in direct or indirect response to the action taken by the first user. With respect to an example activity associated with an example component graph, a first user can take action that is desired by, for example, an entity on a social networking system who wishes to propagate the action on the social networking system. As referenced, the desired action can relate to any type of activity, such as participation in an event, engagement with a media content item, interacting with entities on the social networking system, or any other activity that can be supported by the social networking system. After the first user takes the desired action, an indication of such action can be provided to connections of the first user or other users of the social networking system. Further, the indication can be configured to allow users to access the indication to take the same desired action. In some instances, the indication can be reflected in a story or other content item that is published in the social networking system through news feeds of other users. A second user can take the desired action in direct response to the action taken by the first user. Likewise, a third user can take the desired action in direct response to the action taken by the first user. An indication referencing the action taken by the second user and inviting the same desired action can be provided to connections of the second user or other users of the social networking system. As a result, a fourth user can take the desired action in direct response to the action taken by the second user and in indirect response to the action taken by the first user. An indication referencing the action taken by the fourth user and inviting the same desired action can be provided to connections of the fourth user or other users of the social networking system. As a result, a fifth user can take the desired action in direct response to the fourth user and in indirect response to the first user. Further, as a result, a sixth user can take the desired action in direct response to the fourth user and in indirect response to the first user. An indication referencing the action taken by the sixth user and inviting the same desired action can be provided to connections of the sixth user or other users of the social networking system. As a result, a seventh user can take the desired action in direct response to the sixth user and in indirect response to the first user. Many variations in other example component graphs are possible.

With respect to the foregoing example, the example component graph relating to a type of activity can include nodes. Each node represents a user who took the desired action and the activity associated with the component graph as a user-activity pair. The nodes can be configured or organized in a cascade to reflect the sequence of desired actions taken by the users, as described above. In this regard, a first node of the example component graph can be associated with the first user. A second node associated with the second user can be connected to the first node. In addition, a third node associated with the third user can be connected to the first node. A fourth node associated with the fourth user can be connected to the second node. A fifth node associated with the fifth user can be connected to the fourth node. In addition, a sixth node associated with the sixth user can be connected to the fourth node. A seventh node associated with the seventh user can be connected to the sixth node. Many variations are possible for other component graphs.

The impact metric module 256 can determine an impact metric for a first user. The impact metric can be an indication that informs the accuracy of (or validates) an influence score for the first user. The impact metric module 256 can determine an impact metric for each user for whom an influence score has been generated. The impact metric can be generated in a variety of manners. In some embodiments, the impact metric for a first user with respect to a type of activity can be based on a count of downstream users who took downstream action in direct or indirect response to an action taken by the first user. The count of downstream users can be determined through analysis of an associated component graph. For example, with respect to the example activity associated with the example component graph as described above, the count of downstream users in relation to the first user is six. In some embodiments, when an impact metric for a first user is sought for a particular type of event, a component graph including the first user that relates to the particular type of event can be evaluated to generate the impact metric. In such embodiments, if a plurality of component graphs include the first user and relate to the particular type of event, the plurality of component graphs can be evaluated to determine their respective impact metrics. The respective impact metrics can be combined (e.g., averaged) to generate an aggregate impact metric.

The comparison module 258 can compare an influence score for a first user and an impact metric for the first user. In some embodiments, either an influence score for a first user or an impact metric for the first user, or both, are normalized to allow for direct comparison. The comparison between the influence score and the impact metric can inform whether the influence score is accurate. For example, assume a difference between an influence score and an impact metric for a first user in relation to a particular type of activity is relatively large. In this example, the influence score can be determined to be relatively inaccurate with respect to the particular type of activity. As another example, assume a difference between an influence score and an impact metric for a first user in relation to a particular type of activity is relatively small. In this example, the influence score can be determined to be relatively accurate with respect to the particular type of activity. As described in more detail herein, the comparison of an influence score and an impact metric for a first user can be used to train and adjust weights between nodes in a first graph on which the influence score is based.

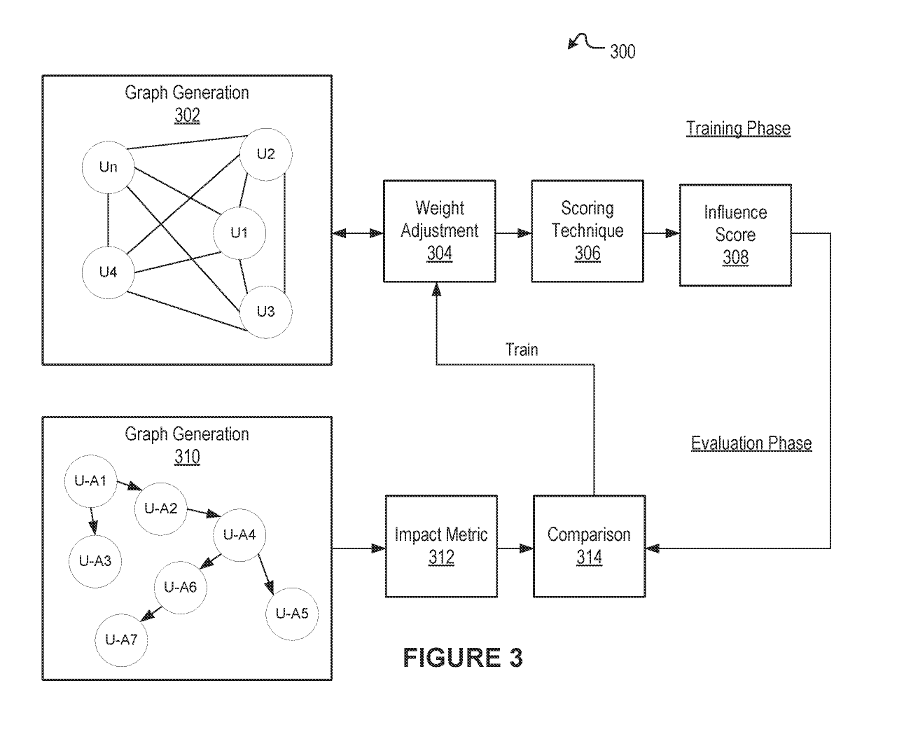

FIG. 3 illustrates an example scenario 300 for determining influence scores of users, according to an embodiment of the present technology. In a training phase of the scenario 300, a first graph is generated by graph generation 302. The first graph can include nodes representing the users and connections between nodes represented by weights, as discussed in more detail herein. A simplified example first graph of nodes associated with users (i.e., U1, U2, U3, U4, . . . , Un) is shown. A weight can reflect one or more parameters that describe relationship strength between two nodes. The parameters relating to two nodes can be combined to generate the weight between the nodes in any suitable manner. Based at least in part on weights associated with the first graph, a scoring technique 306, such as a page ranking algorithm, can generate an influence score 308 for a first user or other users reflected in the first graph. Weight adjustment 304 can receive information relating to a comparison 314 between the influence score 308 and an impact metric 312 associated with a first user. Based on the comparison 314, weights associated with the first graph can be trained and adjusted to allow more accurate generation of influence scores.

In an evaluation phase of the scenario 300, graph generation 310 can generate a second graph including component graphs. The second graph can reflect one or more types of activities in which actions taken by users directly or indirectly resulted in the same actions taken by other users. Each component graph can relate to an activity or a type of activity and can include a configuration of nodes reflecting a first user who took desired action and other users who took direct or indirect responsive action. A simplified example component graph of nodes is shown. Each node is associated with a user-activity pair. As shown, a first user (i.e., U-A1) has taken an action that has resulted in downstream action by other users (i.e., U-A2, U-A3, U-A4, U-A5, U-A6, U-A7) in direct or indirect response to the action taken by the first user. For a first user, an impact metric 312 can be determined. The impact metric 312 can be based on a count of downstream users who took downstream action in direct or indirect response to an action taken by the first user. The impact metric 312 and the influence score 308 associated with the first user can be provided to a comparison 314 to determine a difference value between the influence score 308 and the impact metric 312. The difference value can be provided to the weight adjustment 304 to train the weights associated with the first graph on which the scoring technique 308 is based. In a similar manner, influence scores and impact metrics can be determined for other users and their difference values can be used to train weights of the first graph. Many variations are possible.

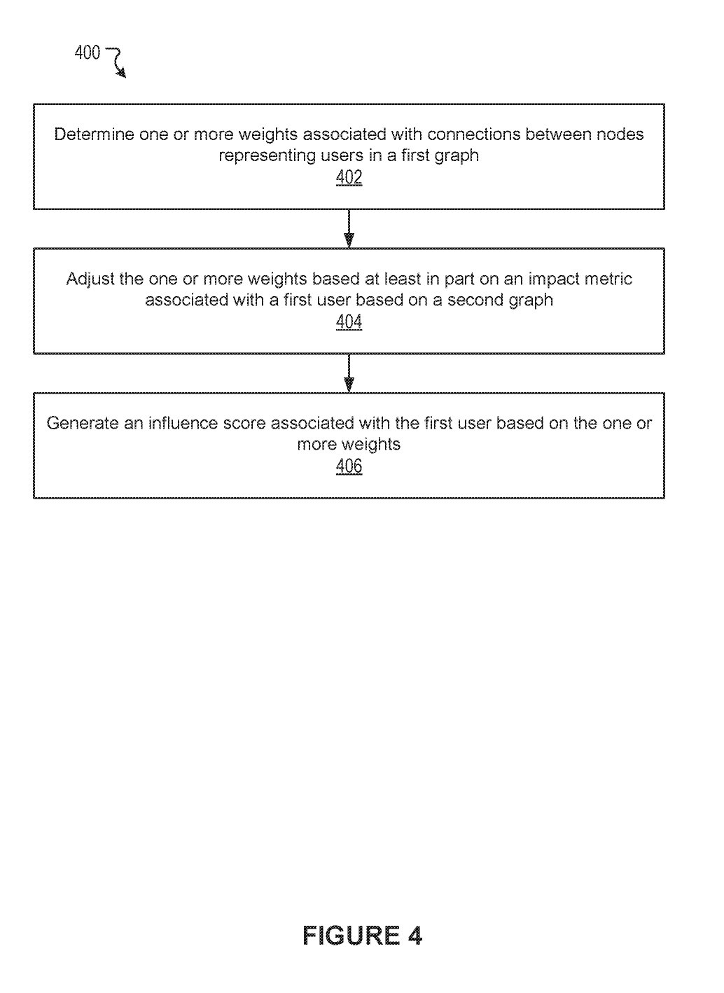

FIG. 4 illustrates an example method 400 to determine an influence score, according to an embodiment of the present technology. It should be appreciated that there can be additional, fewer, or alternative steps performed in similar or alternative orders, or in parallel, in accordance with the various embodiments and features discussed herein unless otherwise stated.

At block 402, the method 400 can determine one or more weights associated with connections between nodes representing users in a first graph. At block 404, the method 400 can adjust the one or more weights based at least in part on an impact metric associated with a first user based on a second graph. At block 406, the method 400 can generate an influence score associated with the first user based on the one or more weights. Other suitable techniques that incorporate various features and embodiments of the present technology are possible.

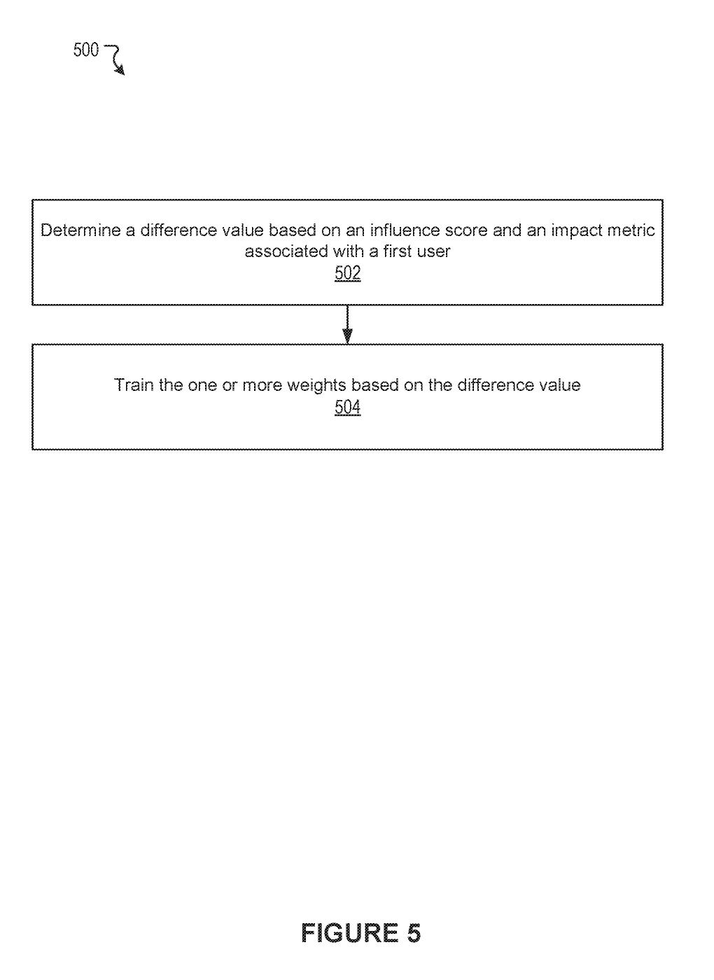

FIG. 5 illustrates an example method 500 to adjust weights on which an influence score is based, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can determine a difference value based on an influence score and an impact metric associated with a first user. At block 504, the method 500 can train the one or more weights based on the difference value. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an influence determination module 646. The influence determination module 646 can be implemented with the influence determination module 102, as discussed in more detail herein. In some embodiments, one or more functionalities of the influence determination module 646 can be implemented in the user device 610.

### Hardware Implementation

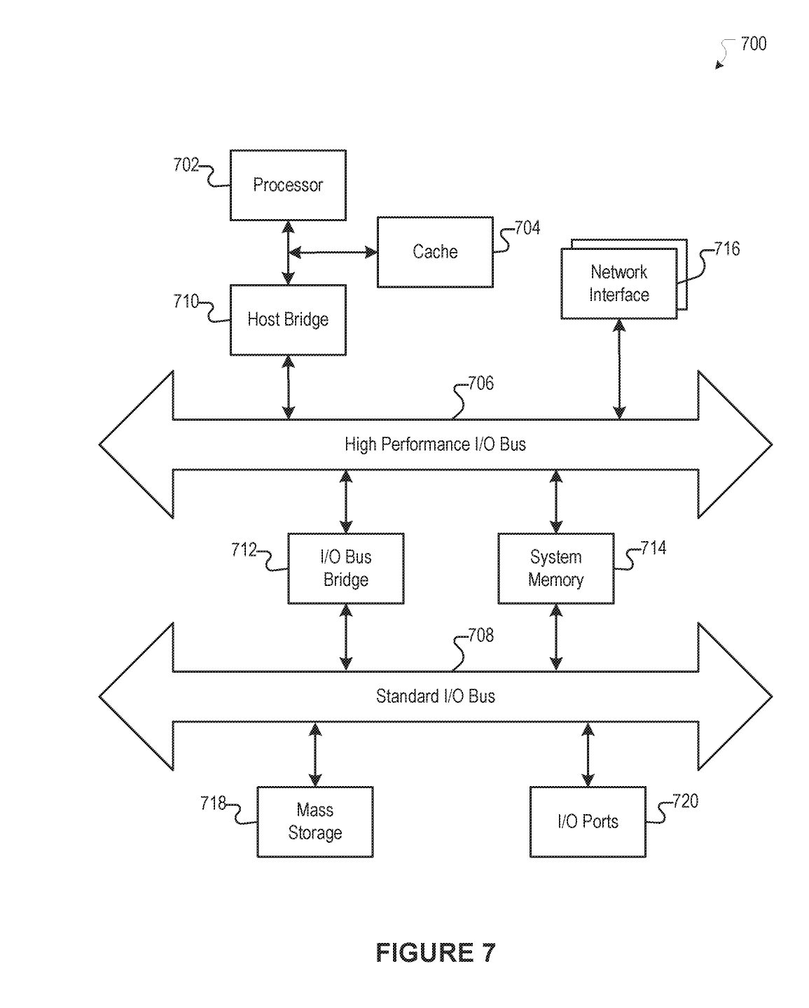

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, one or more weights associated with connections between nodes representing users in a first graph;
adjusting, by the computing system, the one or more weights based at least in part on an impact metric associated with a first user based on a second graph; and
generating, by the computing system, an influence score associated with the first user based on the one or more weights.

2. The computer-implemented method of claim 1, wherein the one or more weights reflect a relationship between a first node associated with the first user and a second node associated with a second user.

3. The computer-implemented method of claim 2, wherein the one or more weights are based on at least one of a first parameter relating to a count of times that the second user took action in response to action taken by a first user, a second parameter relating to a count of times that the second user received an invitation to take action from the first user, and a third parameter relating to a coefficient value representing an affinity between the first user and the second user.

4. The computer-implemented method of claim 1, wherein the impact metric is determined from a component graph of the second graph.

5. The computer-implemented method of claim 1, wherein the impact metric is based on a count of other users who took downstream action in direct or indirect response to an action taken by the first user as reflected in an associated component graph.

6. The computer-implemented method of claim 1, further comprising:
generating a component graph of the second graph reflecting the first user who took an action and other users who took downstream action in direct or indirect response to the action taken by the first user.

7. The computer-implemented method of claim 6, wherein the component graph relates to a type of activity.

8. The computer-implemented method of claim 7, wherein the type of activity relates to at least one of participation in an event, engagement with a media content item, or interaction with entities on a social networking system.

9. The computer-implemented method of claim 1, wherein the adjusting the one or more weights comprises:
determining a difference value based on the influence score and an impact metric associated with the first user; and
training the one or more weights based on the difference value.

10. The computer-implemented method of claim 1, wherein the second graph comprises at least one component graph including nodes associated with user-activity pairs, the at least one component graph representing an action and associated downstream actions.

11. A system comprising:
at least one processor; and
a memory storing instructions that, when executed by the at least one processor, cause the system to perform:
determining one or more weights associated with connections between nodes representing users in a first graph;
adjusting the one or more weights based at least in part on an impact metric associated with a first user based on a second graph; and
generating an influence score associated with the first user based on the one or more weights.

12. The system of claim 11, wherein the one or more weights reflect a relationship between a first node associated with the first user and a second node associated with a second user.

13. The system of claim 12, wherein the one or more weights are based on at least one of a first parameter relating to a count of times that the second user took action in response to action taken by a first user, a second parameter relating to a count of times that the second user received an invitation to take action from the first user, and a third parameter relating to a coefficient value representing an affinity between the first user and the second user.

14. The system of claim 11, wherein the impact metric is determined from a component graph of the second graph.

15. The system of claim 11, wherein the impact metric is based on a count of other users who took downstream action in direct or indirect response to an action taken by the first user as reflected in an associated component graph.

16. A non-transitory computer-readable storage medium including instructions that, when executed by at least one processor of a computing system, cause the computing system to perform a method comprising:
determining one or more weights associated with connections between nodes representing users in a first graph;
adjusting the one or more weights based at least in part on an impact metric associated with a first user based on a second graph; and
generating an influence score associated with the first user based on the one or more weights.

17. The non-transitory computer-readable storage medium of claim 16, wherein the one or more weights reflect a relationship between a first node associated with the first user and a second node associated with a second user.

18. The non-transitory computer-readable storage medium of claim 17, wherein the one or more weights are based on at least one of a first parameter relating to a count of times that the second user took action in response to action taken by a first user, a second parameter relating to a count of times that the second user received an invitation to take action from the first user, and a third parameter relating to a coefficient value representing an affinity between the first user and the second user.

19. The non-transitory computer-readable storage medium of claim 16, wherein the impact metric is determined from a component graph of the second graph.

20. The non-transitory computer-readable storage medium of claim 16, wherein the impact metric is based on a count of other users who took downstream action in direct or indirect response to an action taken by the first user as reflected in an associated component graph.
